(19) United States
(12) Patent Application Publication
(10) Pub. No.: US 2026/0261069 A1
(43) Pub. Date: Sep. 3, 2026

(54) CONNECTOR

(71) Applicant: SUMITOMO WIRING SYSTEMS, LTD., Mie (JP)

(72) Inventor: Takahiro TSUCHIYA, Mie (JP)

(21) Appl. No.: 18/863,648

(22) PCT Filed: Apr. 28, 2023
(86) PCT No.: PCT/JP2023/016819

§ 371 Date: Nov. 7, 2024

(30) Foreign Application Priority Data
May 16, 2022 (JP) 2022-079989

(51) Int. Cl. H01R 13/424

(52) U.S. Cl. CPC H01R 13/424

(57) ABSTRACT

A housing (11) has: an attachment hole (24) that is open in three directions out of four directions that are upward, downward, leftward, and rightward directions intersecting with a fitting direction in which the connector is to fit into a mating connector (90); and a front portion (25) and a rear portion (26) located forward and rearward, respectively, of the attachment hole (24) in the fitting direction. A retainer (12) has: a retainer body (42) located inside the attachment hole a front abutting portion, e.g., a front mask (43), located forward of the retainer body (42) and in contact with the front portion (25) from the front; and a rear abutting portion (44, 44A) located rearward of the retainer body (42) and in contact with the rear portion (26) from the rear.

### TECHNICAL FIELD

The present disclosure relates to a connector.

### BACKGROUND

A connector described in Patent Document 1 includes a housing that accommodates a terminal fitting, and a retainer (integrated retainer) attached to the housing. An attachment hole (retainer attachment opening) is open in a lower surface of the housing. The retainer has a retainer body (retainer section) inserted into the attachment hole to stop the terminal fitting from coming off.

Connectors described in Patent Documents 2 and 3 each have an attachment hole (fitting groove, groove portion) that is formed in a housing and open in three surfaces, namely the lower, left, and right surfaces of the housing. This housing has a front portion and a rear portion that are located forward and rearward, respectively, of the attachment hole, and a joint portion connecting the front and rear portions to each other in the attachment hole. Specifically, a beam-shaped section above a fitting groove denoted by reference numeral 13 in FIG. 1 of Patent Document 2, and a beam-shaped section above a groove denoted by reference numeral 32a in FIG. 10 of Patent Document 3 may each correspond to the aforementioned joint portion.

### PRIOR ART DOCUMENT

### Patent Document

Patent Document 1: JP 2012-129111 A

Patent Document 2: JP 2008-171626 A

Patent Document 3: JP 2020-202031 A

### SUMMARY OF THE INVENTION

### Problems to be Solved

In the case of Patent Documents 2 and 3, with the connector attached to an attachment target such as a vehicle, for example, a wire pulled out backward from the rear portion of the housing may vibrate in the up-down direction, causing an external force to act on the housing to expand the front and rear portions apart from the connecting portion. The external force acting on the housing will concentrate stress (load) on the joint portion, which may cause the joint portion to break.

The present disclosure aims to provide a connector capable of improving the strength of the housing.

### Means to Solve the Problem

A connector of the present disclosure includes: a terminal fitting; a housing accommodating the terminal fitting; and a retainer attached to the housing and restricting withdrawal of the terminal fitting from the housing, wherein the housing has: an attachment hole that is open in three directions out of four directions that are upward, downward, leftward, and rightward directions intersecting with a fitting direction in which the connector is to fit into a mating connector; and a front portion and a rear portion located forward and rearward, respectively, of the attachment hole with respect to the fitting direction, and the retainer has: a retainer body located inside the attachment hole; a front abutting portion located forward of the retainer body and in contact with the front portion from front; and rear abutting portions located rearward of the retainer body and in contact with the rear portion from rear.

### Effect of the Invention

According to the present disclosure, it is possible to provide a connector capable of ensuring the strength of the housing.

### BRIEF DESCRIPTION OF THE DRAWINGS

FIG. 1 is a perspective view of a connector according to Embodiment 1 of the present disclosure viewed from above.

FIG. 2 is a side view of the connector of Embodiment 1.

FIG. 3 is a side cross-sectional view of the connector of Embodiment 1.

FIG. 4 is a perspective view of a housing of Embodiment 1 viewed from below.

FIG. 5 is a perspective view of a retainer of Embodiment 1 viewed from above.

FIG. 6 is a perspective view of the retainer of Embodiment 1 viewed from below.

FIG. 7 is an enlarged cross-sectional view of a region where mutually opposing faces of a rear abutting portion and an abutted portion are in contact with each other according to Embodiment 1.

FIG. 8 is a side view of a connector according to Embodiment 2 of the present disclosure.

FIG. 9 is an enlarged cross-sectional view of a region where a rear abutting portion is in contact with a rear portion according to Embodiment 2.

FIG. 10 is a back view of the connector of Embodiment 2.

### DETAILED DESCRIPTION TO EXECUTE THE INVENTION

### Description of Embodiments of Present Disclosure

Firstly, modes for carrying out the present disclosure are listed and described.

(1) A connector of the present disclosure is: a connector including: a terminal fitting; a housing accommodating the terminal fitting; and a retainer attached to the housing and restricting withdrawal of the terminal fitting from the housing, wherein the housing has: an attachment hole that is open in three directions out of four directions that are upward, downward, leftward, and rightward directions intersecting with a fitting direction in which the connector is to fit into a mating connector; and a front portion and a rear portion located forward and rearward, respectively, of the attachment hole with respect to the fitting direction, and the retainer has: a retainer body located inside the attachment hole; a front abutting portion located forward of the retainer body and in contact with the front portion from front; and rear abutting portions located rearward of the retainer body and in contact with the rear portion from rear.

According to this configuration, the attachment hole is open in three direction in the housing. Thus, an outer wall section that closes the left and right outer sides of the attachment hole can be omitted from the housing, and the dimension in the left-right direction (width dimension) of the housing can be reduced.

Further, with the retainer body positioned inside the attachment hole, the front abutting portion is in contact with the front portion of the housing from the front, and the rear abutting portion is in contact with the rear portion from the rear. Thus, even if a force that expands (separates) the front and rear portions away from each other acts on the housing, excessive stress can be prevented from being applied to the joint area connecting the front portion and the rear portion. As a result, the strength of the housing can be ensured.

Moreover, the retainer body, the front abutting portion, and the rear abutting portion are integrated with the retainer. Thus, it is possible to reduce the number of parts and prevent the structure of the connector from becoming complex compared to the case where members separate from the retainer are in contact with the front and rear portions.

(2) It is preferable that the rear portion has, on left and right side surfaces thereof, abutted portions in contact with the respective rear abutting portions.

According to this configuration, the shape of the abutted portion can be simplified compared to the case where the abutted portion is formed inward of the rear portion. Further, if the retainer has a pair of rear abutting portions that are paired with the respective abutted portions, the retainer can be attached to the housing in a balanced manner.

(3) It is preferable that the retainer has catching portions each having a hook shape in a side view, the catching portions being formed by the rear abutting portions and connecting portions connecting the retainer body and the rear abutting portions, and each of the abutted portions has a protruding shape fitting into a recess formed between the retainer body and a corresponding one of the catching portions.

According to this configuration, the catching portion can also come into contact with the abutted portion from the connecting portion side, thereby stabilizing the attaching posture of the retainer relative to the housing. Furthermore, the contact state between the catching portion and the abutted portion can be checked by viewing the connector from the side.

(4) It is favorable that the rear portion has restriction portions located rearward of the respective abutted portions, and the rear abutting portions are sandwiched between the respective restriction portions and the respective abutted portions.

According to this configuration, the restriction portion restricts the retreat of the rear abutting portion, which can thus be maintained in a state in contact with the abutted portion.

(5) It is preferable that mutually opposing faces of each of the rear abutting portions and a corresponding one of the abutted portions are dovetail slopes in contact with each other in a direction in which the rear abutting portion expands from the abutted portion outward in the left-right direction.

According to this configuration, the dovetail slopes restrict the expansion of the rear abutting portion to the outer sides in the left-right direction. Thus, the rear abutting portion can be maintained in a state in contact with the abutted portion more preferably.

(6) It is preferable that the front abutting portion is a front mask covering a front surface of the front portion.

According to this configuration, the housing need not have a special structure as a front abutting portion, and the connector can be prevented from becoming complex.

### Details of Embodiments of the Present Disclosure

Specific examples of the present disclosure are described below with reference to the drawings. Note that the present invention is not limited to these examples but is defined by the claims, and is intended to include all changes made within the meaning and scope equivalent to the claims.

### Embodiment 1

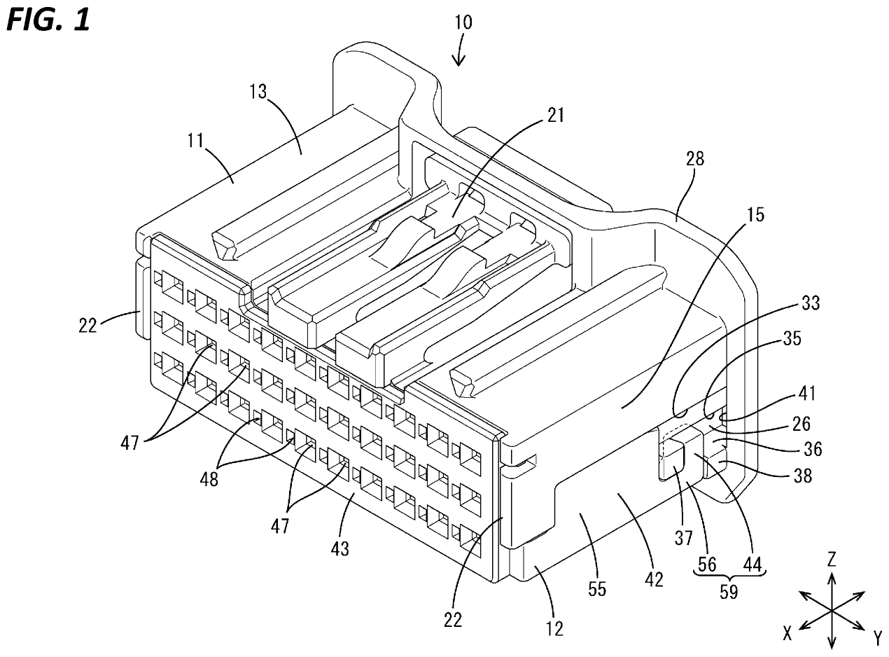

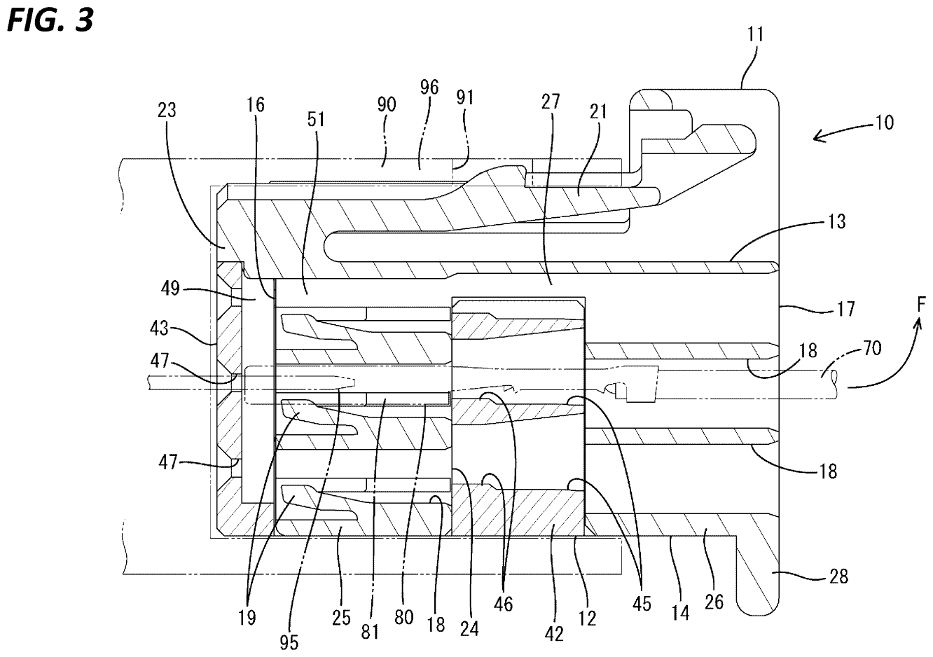

A connector 10 according to Embodiment 1 of the present disclosure includes a housing 11, a retainer 12 attached to the housing 11, and a terminal fitting 80 accommodated in the housing 11, as shown in FIG. 3. The housing 11 can be fitted to a mating connector 90. In the following description, the “front” with respect to the front-back direction refers to the side on which the housing 11 is fitted to the mating connector 90. The front corresponds to the left in FIG. 3. The up-down direction is based on the up-down direction in FIG. 3. The left-right direction is based on the paper thickness direction in FIG. 3. The left-right direction may also be referred to as a widthwise direction. In FIG. 1, sign X denotes the front-back direction, sign Y denotes the left-right direction, and sign Z denotes the up-down direction. The up-down direction does not necessarily coincide with the direction of gravity when the connector 10 is in the state of being attached to an attachment target such as a vehicle.

### Housing and Terminal Fitting

The housing 11 is made of synthetic resin and has a rectangular close shape as a whole. The housing 11 has outer surfaces including an upper surface 13 that faces upward, a lower surface 14 that faces downward, left and right side surface 15 that face outward in the left-right direction, a front surface 16 that faces forward, and a rear surface 17 that faces rearward, as indicated at respective appropriate positions in FIGS. 1 to 4.

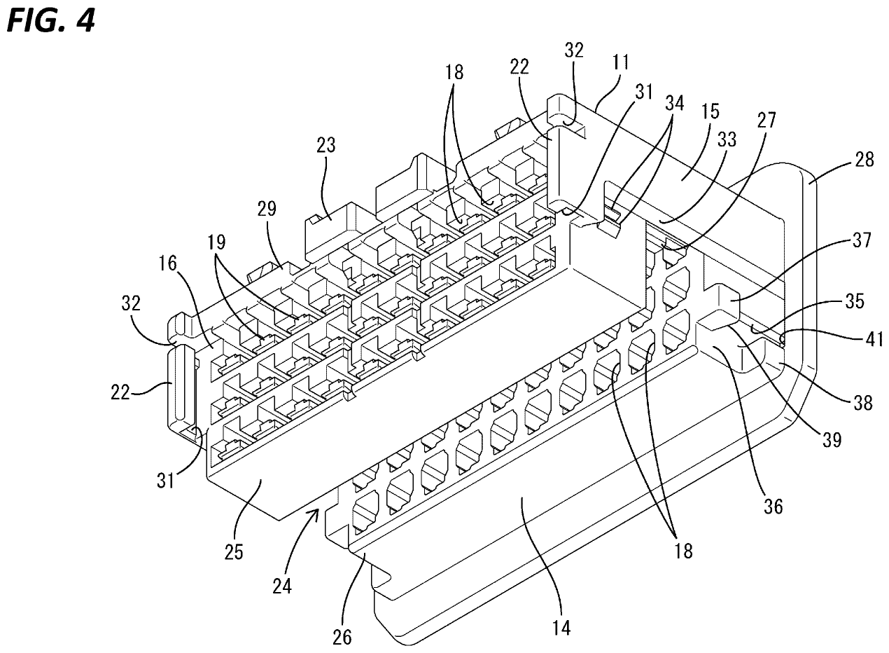

As shown in FIGS. 3 and 4, the housing 11 has a plurality of cavities 18 that extend through the housing 11 in the front-back direction. In the housing 11, the cavities 18 are arranged in a plurality of levels (three levels shown in the figures) in the up-down direction, and a large number of cavities 18 are arranged in lines in the left-right direction. The housing 11 has elastically deformable lances 19 protruding forward from an inner lower surface of each cavity 18.

The terminal fitting 80 is made of conductive metal, and has a box portion 81 at its front end, as shown in FIG. 3. The terminal fitting 80 is inserted into a cavity 18 from the rear and are primarily prevented from coming off from the housing 11 by locking the box portion 81 to a lance 19. A rear end of the terminal fitting 80 is press-fitted to a wire 70. The wire 70 is pulled out rearward from the rear surface 17 of the housing 11.

As shown in FIG. 3, the housing 11 has a lock arm 21 that extends rearward from the front end of the upper surface 13. The lock arm 21 is elastically deformable in the up-down direction with a base end portion 23, i.e., a root section on the front end side, as a support point. The lock arm 21 is locked to a lock receiver 91 formed in the mating connector 90, thereby maintaining the housing 11 and the mating connector 90 in a fitted state.

As shown in FIG. 4, the housing 11 has an attachment hole 24 that is open at intermediate portions in the front-back direction of the left and right side surfaces 15 and the lower surface 14. In other words, the attachment hole 24 is open in three directions, namely in the leftward, rightward, and downward directions, at the intermediate portions in the front-back direction of the housing 11.

The housing 11 has a front portion 25 and a rear portion 26, which are located forward and rearward, respectively, of the attachment hole 24. The cavities 18 are formed in the front portion 25 and the rear portion 26. The lances 19 are formed in the front portion 25. As shown in FIGS. 3 and 4, the housing 11 has a joint portion 27 that closes the upper end of the attachment hole 24, extends in the front-back direction to join its front end to the upper end side of the front portion 25 and join its rear end to the upper end side of the rear portion 26. The front portion 25 and the rear portion 26 are joined to each other only via the joint portion 27.

As shown in FIGS. 1 and 4, the rear portion 26 of the housing 11 has a flange 28 that protrudes outward from the rear ends of the upper surface 13, the lower surface 14, and the left and right side surfaces 15. The flange 28 is shaped to cover from above an area of the lock arm 21 close to the rear end, and to be continuous with the entire outer periphery of the housing 11.

As shown in FIG. 4, the front portion 25 of the housing 11 has an eave portion 29 that includes the base end portion 23 of the lock arm 21 and extends in the left-right direction at the upper front end, and a pair of side end portions 22 that extend downward from the left and right ends of the eave portion 29 at the front ends of the left and right side surfaces 15. The front surface 16 of the front portion 25 of the housing 11 is set backward from the front ends of the eave portion 29 and the side end portions 22.

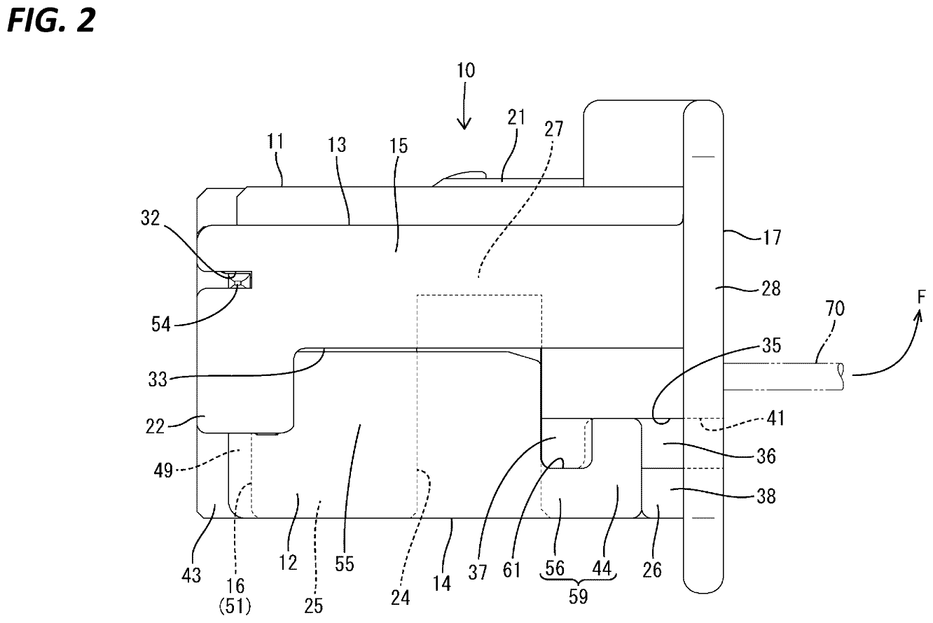

As shown in FIG. 4, the side end portions 22 each have a guide groove 31 that is open in mutually opposing faces thereof and extends in the vertical direction to be open downward. Also, the side end portions 22 each have a front held portion 32 having a cut-out slit shape that is in communication with the guide groove 31 and extends in the front-back direction to be open forward. The guide groove 31 guides the movement of a later-described front mask 43 of the retainer 12. When the retainer 12 reaches a later-described actual locking position, the front held portion 32 is locked to a later-described front holder 54 as shown in FIG. 2, and restricts downward movement of the front mask 43.

As shown in FIGS. 2 and 4, the left and right side surfaces 15 of the housing 11 each have a step surface 33 that demarcates a boundary between the joint portion 27 and the attachment hole 24 and extends in the front-back direction. The front ends of the step surfaces 33 are closed by the respective side end portions 22. As shown in FIG. 4, the step surface 33 faces downward. A lower section (a section having a later-described holder 34) of each side surface 15 is recessed inward in the widthwise direction from an upper section (a section having the front held portion 32) of the side surface 15 via the step surface 33.

As shown in FIG. 4, the left and right side surfaces 15 of the front portion 25 of the housing 11 each have a pair of upper and lower holders 34 (only one of which is show in FIG. 4) below the step surface 33 and rearward of the side end portions 22. Each holder 34 has a rib shape extending in the front-back direction. The holders 34 allows the housing 11 to hold the retainer 12.

As shown in FIGS. 2 and 4, the left and right side surfaces 15 of the rear portion 26 of the housing 11 each have a rear step surface 35 that extends in the front-back direction in an area below the step surface 33, and has an attachment surface 36 that is further recessed inward in the widthwise direction below the rear step surface 35. A later-described catching portion 59 of the retainer 12 is disposed along the attachment surface 36 of the rear portion 26.

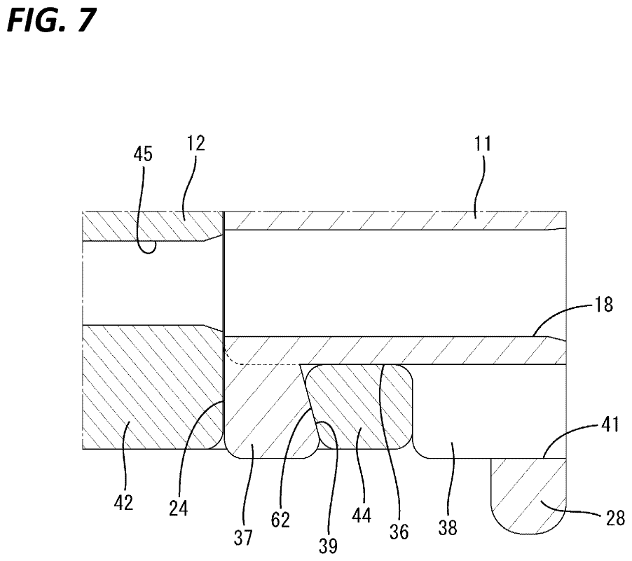

The left and right side surfaces 15 of the rear portion 26 of the housing 11 each have an abutted portion 37 that protrudes from an upper front portion of the attachment surface 36, and a restriction portion 38 that protrudes from a lower rear portion of the attachment surface 36, as shown in FIGS. 2 and 4. The abutted portion 37 has a rectangular prism shape with a front surface being seamlessly continuous with the inner surface of the attachment hole 24. An upper surface of the abutted portion 37 (a surface facing upward and opposing the step surface 33) and the aforementioned rear step surface 35 are located at the same height. The front end of the rear step surface 35 is closed by the abutted portion 37. As shown in FIG. 7, a rear surface of the abutted portion 37 has an inverted-tapered dovetail slope 39 that inclines rearward from the base end side in the protruding direction (the center side in the widthwise direction (the inner side in the widthwise direction) of the housing 11) to the leading end side.

As shown in FIG. 4, the restriction portion 38 has a rectangular columnar shape, and has a rear end integrated with the flange 28. The abutted portion 37 and the restriction portion 38 are shifted from each other in the up-down direction and spaced apart from each other in the front-back direction. As shown in FIG. 2, a later-described rear abutting portion 44 of the retainer 12 is disposed between the abutted portion 37 and the restriction portion 38. The abutted portion 37 is arranged to be in contact with a front surface of the rear abutting portion 44, and the restriction portion 38 is arranged to be in contact with a rear surface of the rear abutting portion 44.

The abutted portion 37 and the restriction portion 38 have the same protruding dimension. Leading end surfaces in the protruding direction (leading end surfaces in the widthwise direction) of the abutted portion 37 and the restriction portion 38 are flat along the front-back direction and the up-down direction.

The flange 28 has a pair of left and right through-holes 41 (only one of which is shown in FIGS. 1, 4, and 7). The abutted portions 37 are visible from the rear of the housing 11 through the through-holes 41 when the housing 11 is in an individual state.

### Retainer

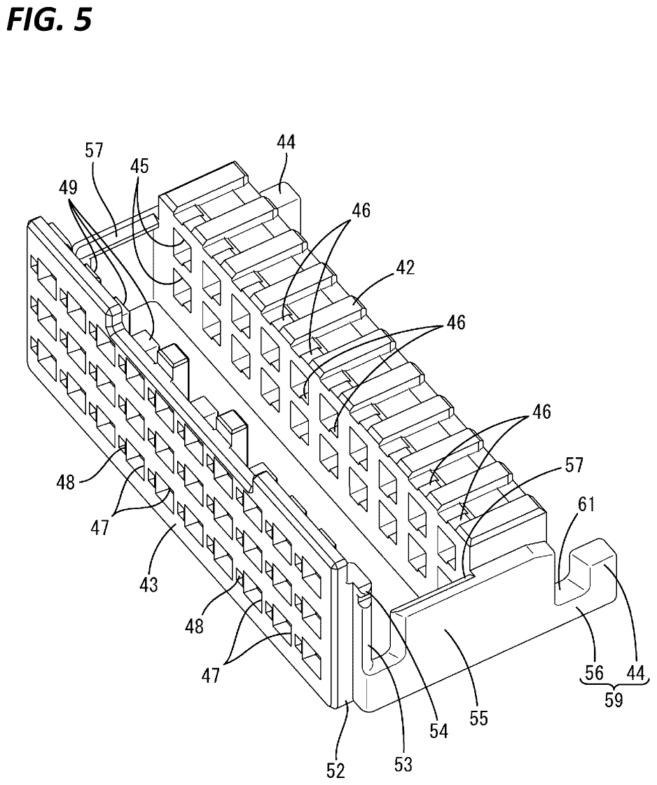

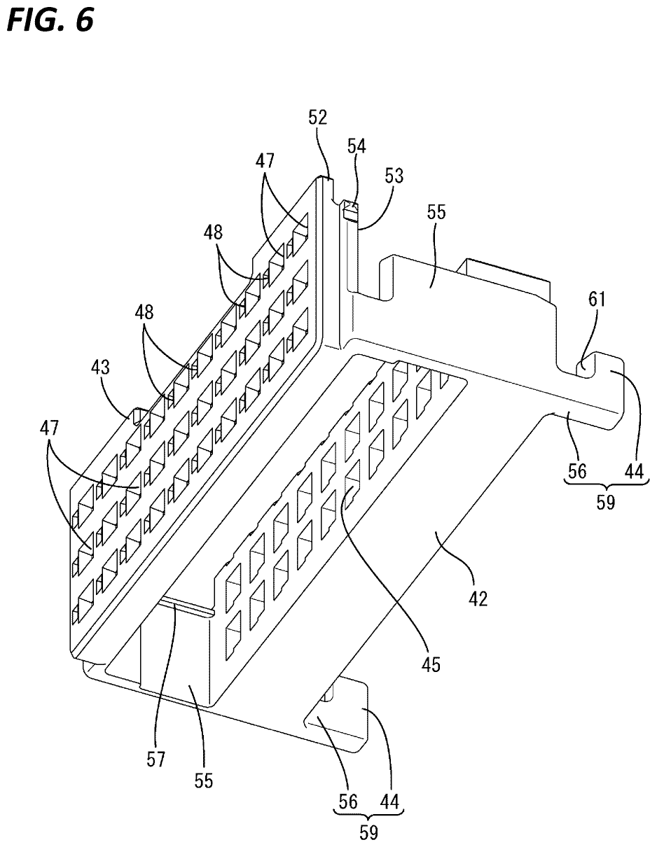

The retainer 12 is made of synthetic resin, and has a retainer body 42, a front mask 43 serving as a front abutting portion located forward of the retainer body 42, and rear abutting portions 44 located rearward of the retainer body 42, as shown in FIGS. 5 and 6. The retainer body 42, the front mask 43, and the rear abutting portions 44 are integrated with each other. A pair of left and right rear abutting portions 44 are formed at the ends in the left-right direction of the retainer 12. The retainer 12 is movable between a temporary locking position (not shown) and an actual locking position (see FIGS. 1 to 3) relative to the housing 11.

The retainer body 42 has a rectangular block shape elongate in the left-right direction, and is fittable into the attachment hole 24 of the housing 11 as shown in FIG. 3. The retainer body 42 deeply fits into the attachment hole 24 while the retainer 12 is moving from the temporary locking position to the actual locking position. The retainer body 42 has a plurality of insertion holes 45. When the retainer 12 is at the actual locking position, the insertion holes 45 are in communication in the front-back direction with the respective cavities 18 (except for the cavities 18 in the uppermost level) in the front portion 25 and the rear portion 26. As shown in FIG. 5, the retainer body 42 has a plurality of stopping portions 46 that protrude from inner lower surfaces of the insertion holes 45 and from an upper surface of the retainer body 42. The stopping portions 46 are located at positions corresponding to the respective cavities 18. When the retainer 12 is at the temporary locking position, the stopping portions 46 are located at retracted positions below the respective cavities 18. At this time, the terminal fitting 80 can be inserted into each cavity 18 from the rear. When the retainer 12 is at the actual locking position, the stopping portions 46 proceed into the respective cavities 18 and are each lockable to the box portion 81 of the terminal fitting 80 as shown in FIG. 3. The terminal fitting 80 are secondarily prevented from coming off from the housing 11 by the corresponding stopping portion 46.

The front mask 43 has a plate shape and covers the front surface 16 of the front portion 25 of the housing 11. The front mask 43 has a plurality of tab insertion holes 47 at positions corresponding to the respective cavities 18. When the housing 11 and the mating connector 90 are in a fitted state as shown in FIG. 3, tabs 95 of mating terminals that are attached to the mating connector 90 from the front are inserted into the respective tab insertion holes 47. The tab 95 of each mating terminal is inserted into the box portion 81 of the terminal fitting 80 and electrically connected to the terminal fitting 80.

The front mask 43 has a plurality of jig insertion holes 48 at positions corresponding to the respective lances 19, as shown in FIG. 6. Each jig insertion hole 48 is next to a corresponding tab insertion hole 47 in the left-right direction in the front mask 43. Although not shown in the figures, when the retainer 12 is at the temporary locking position, a jig is inserted into a jig insertion hole 48 from the front, and the terminal fitting 80 can be removed from the cavity 18 as a result of a leading end of the jig pulling down the lance 19.

As partially shown in FIG. 5, the front mask 43 has, in its rear surface, a plurality of partitions 49 that are spaced apart from each other in the left-right direction. Each partition 49 extends in the up-down direction between the tab insertion holes 47 in the rear surface of the front mask 43. As shown in FIG. 3, the partitions 49 are connected in the front-back direction to a division wall 51 located between the cavities 18 in the front portion 25 of the housing 11. Although not shown in the figures, the jig insertion holes 48 extend through the respective partitions 49.

The front mask 43 has end surfaces 52, which are plate-thickness surfaces at the ends in the left-right direction as shown in FIG. 5, and has guide ribs 53 extending in the up-down direction at rear portions of the respective end surfaces 52. Each guide rib 53 has a front holder 54 on the upper end side. The guide ribs 53 are fittable to the guide grooves 31 at the side end portions 22. As shown in FIG. 2, the front holders 54 of the guide ribs 53 are locked to the front held portions 32 of the respective side end portions 22.

As shown in FIG. 6, the retainer 12 has a pair of left and right side portions 55 connecting the retainer body 42 and the front mask 43, and a pair of left and right connecting portions 56 connecting the retainer body 42 and the rear abutting portions 44.

The side portions 55 each have a plate shape and extend along the front-back direction from the respective ends in the left-right direction of the retainer body 42 to the respective guide ribs 53 of the front mask 43. The side portions 55 each have a rib-shaped held portion 57 extending in the front-back direction at the upper ends of the mutually opposing faces. The held portions 57 of the side portion 55 are locked to the holders 34, thereby holding the retainer 12 at the temporary locking position or the actual locking position relative to the housing 11.

The connecting portions 56 each have a plate shape and extend along the front-back direction from the respective ends in the left-right direction of the retainer body 42 to the respective rear abutting portions 44. The connecting portions 56 are formed along the lower ends of the retainer 12.

Each rear abutting portion 44 has a plate shape and is formed along the up-down direction. Each rear abutting portion 44 is connected to and intersects with the corresponding connecting portion 56 and has a section protruding upward from the connecting portion 56. Each rear abutting portion 44 and the corresponding connecting portion 56 are integrated by seamlessly connecting their plate faces to form a catching portion 59, which has an L-shape in a side view. As shown in FIG. 5, the plate thickness (the dimension in the left-right direction) of the catching portion 59 is greater than the plate thickness of the side portion 55. A recess 61 having a U-shape in a side view is formed that is open upward and in the left-right direction between a rear surface of the retainer body 42, a front surface of the rear abutting portion 44 (a later-described dovetail slope 62), and an upper surface of the connecting portion 56, i.e., between the retainer body 42 and the catching portion 59. As shown in FIG. 2, each abutted portion 37 of the housing 11 is fittable to the corresponding recess 61. As shown in FIG. 7, the front surface of the rear abutting portion 44 is a dovetail slope 62 that inclines rearward from the inner side in the widthwise direction (the center side in the widthwise direction (the inner side in the widthwise direction) of the retainer 12) to the outer side.

### Effects of Connector

When the retainer 12 is at the actual locking position relative to the housing 11, the entire retainer body 42 fits into the attachment hole 24 of the housing 11, and the front mask 43 is positioned facing the front surface 16 of the front portion 25 of the housing 11, as shown in FIG. 3. The partitions 49 of the front mask 43 are positioned so as to be able to come into contact with front end surfaces of the division walls 51 in the front surface 16 of the front portion 25.

The side portions 55 are positioned below the step surfaces 33 in the left and right side surfaces 15 of the front portion 25, as shown in FIGS. 1 and 2. The catching portions 59 are positioned below the rear step surfaces 35 of the left and right side surfaces 15 of the rear portion 26, and faces the attachment surfaces 36. Overall, the end surfaces in the left-right direction of the retainer 12 are positioned at the same position in the widthwise direction as, or at positions recessed inward in the widthwise direction from, the faces of the left and right side surfaces 15 of the housing 11 that are above the step surfaces 33 (i.e., the outer surfaces of the side end portions 22 in FIG. 3).

The rear abutting portion 44 of each catching portion 59 is inserted from below between the abutted portion 37 and the restriction portion 38 and sandwiched therebetween in the left and right side surfaces 15 of the rear portion 26. As shown in FIG. 7, the dovetail slopes 39 and 62 of the rear abutting portion 44 and the abutted portion 37 face each other. Each abutted portion 37 is positioned such that the dovetail slope 39 overlaps the rear abutting portion 44 from the outer side in the widthwise direction.

When each electric wire 70 pulled out from the rear portion 26 of the housing 11 vibrates in the up-down direction or is pulled upward with the connector 10 attached to an attachment target such as a vehicle (not shown), an external force (e.g., see arrow F in FIGS. 2 and 3) that causes the front portion 25 and the rear portion 26 to expand apart (separate) from each other may act on the housing 11 via the joint portion 27.

In this respect, when the external force acts in the case of Embodiment 1, the partitions 49 of the front mask 43 can come into contact with the front surface 16 of the front portion 25 (the front end surfaces of the division walls 51) from the front, and the rear abutting portions 44 can come into contact with the abutted portions 37 of the rear portion 26 from the rear, as shown in FIG. 2. Further, the retainer 12 is held by the housing 11 due to the locking effect between the front holders 54 and the front held portions 32 and the locking effect between the holders 34 and the held portions 57.

If, unlike Embodiment 1, the connector 10 does not have the rear abutting portions 44 and the abutted portions 37, there is a concern that an upward external force will cause the rear portion 26 to expand apart from the front portion 25 (which may also involve expansion of the hood 96 (see FIG. 3) of the mating connector 90), causing the width in the front-back direction of the attachment hole 24 to increase and causing the joint portion 27 to bend and deform, resulting in breakage of the joint portion 27 in the worst case scenario.

In contrast, in Embodiment 1, the connector 10 has the rear abutting portions 44 and the abutted portions 37, and the retainer 12 connects the front portion 25 and the rear portion 26, as mentioned above. Therefore, it is possible to prevent the front portion 25 and the rear portion 26 from expanding apart from each other with the joint portion 27 therebetween and avoid excessive stress being applied to the joint portion 27. As a result, the connector 10 can ensure the strength of the housing 11.

In particular, in Embodiment 1, the mutual contact between the dovetail slopes 39 and 62 of each rear abutting portion 44 and the corresponding abutted portion 37 makes it unlikely for the rear abutting portion 44 to expand in the direction away from the attachment surface 36. That is, the rear section of the retainer 12 is firmly locked to the rear portion 26, which can then be prevented more reliably from expanding away from the front portion 25. Further, the rear surfaces of the rear abutting portions 44 come into contact with the restriction portions 38, thereby suppressing the rearward displacement of the rear abutting portion 44. Furthermore, due to the abutted portions 37 fitting into the recesses 61 formed between the retainer body 42 and the catching portion 59, the rear abutting portions 44 of the catching portions 59 can come into contact with the rear surfaces (the dovetail slopes 39) of the abutted portions 37, and the connecting portions 56 of the catching portions 59 can come into contact with the lower surfaces of the abutted portions 37. This makes a structure that makes it unlikely for the rear abutting portions 44 to incline relative to the abutted portions 37.

As a result, the rear abutting portions 44 can be maintained in contact with the abutted portions 37, and the front portion 25 and the rear portion 26 can be more preferably prevented from expanding apart from each other.

### Embodiment 2

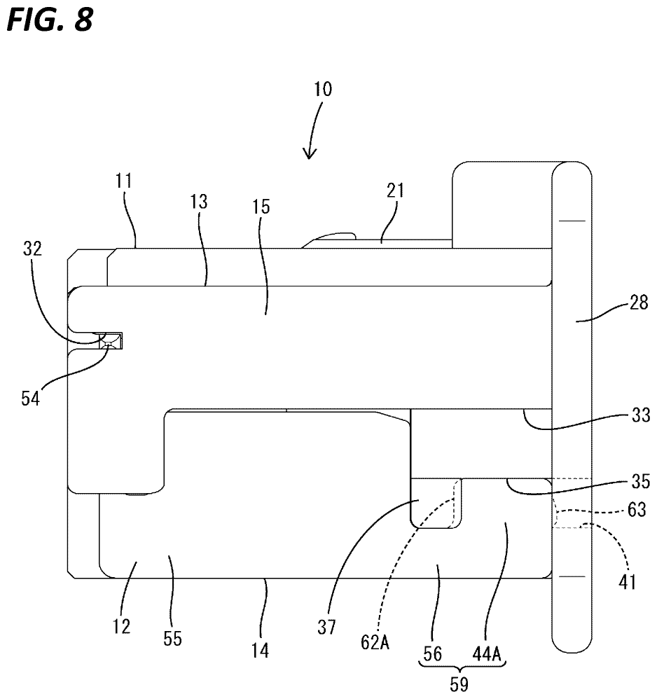

Embodiment 2 of the present disclosure employs a structure in which the retainer 12 is locked to the flange 28 of the housing 11 as shown in FIGS. 8 to 10, and is different from the above-described Embodiment 1 in this respect.

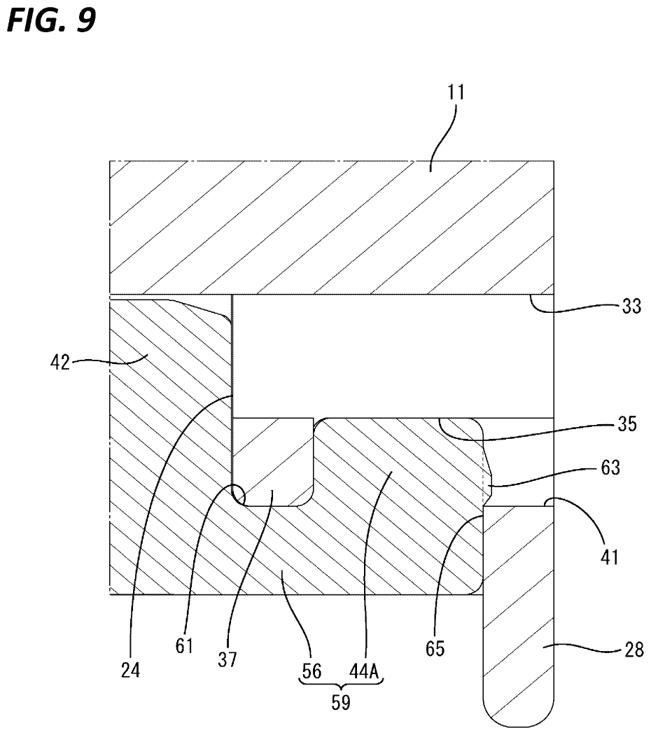

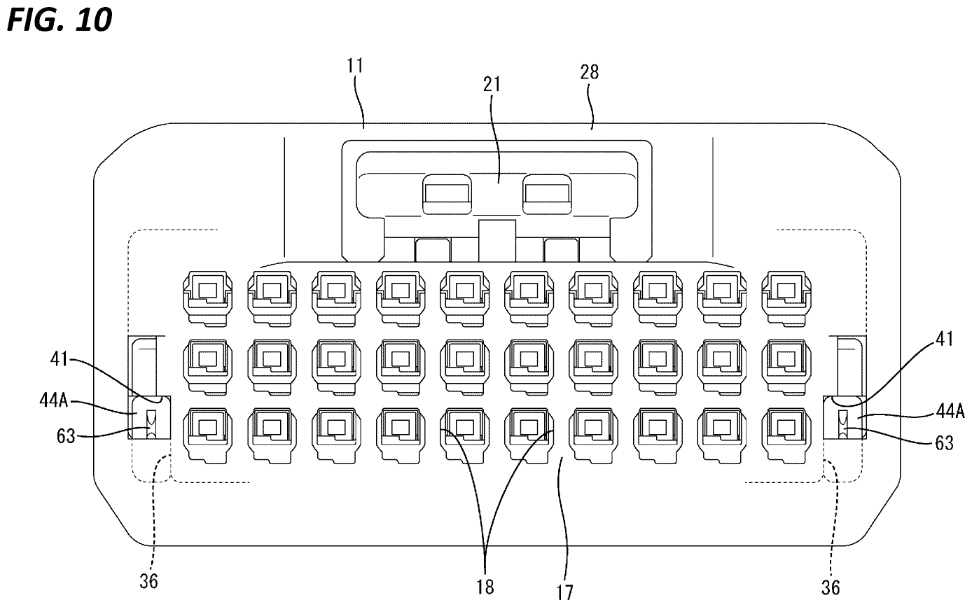

The housing 11 does not have the restriction portions 38 protruding from the attachment surfaces 36 (see FIG. 10), and has recesses 65 that hold rear abutting portions 44A between the abutted portions 37 and the flange 28. As shown in FIG. 9, the width in the front-back direction (the plate width in the front-back direction) of each rear abutting portion 44A is larger than the width in the up-down direction (the plate thickness in the up-down direction) of each connecting portion 56, and corresponds to the width in the front-back direction of each recess 65 (the separation distance in the front-back direction between the abutted portion 37 and the flange 28 in FIG. 9).

Similar to Embodiment 1, a front surface of each rear abutting portion 44A is a dovetail slope 62A (not shown in detail), which comes into contact with the dovetail slope 39 of the corresponding abutted portion 37. As shown in FIG. 10, a rear surface of each rear abutting portion 44A has a lower surface in contact with the front surface of the flange 28, and has an upper portion facing the corresponding through-hole 41 in the flange 28. In Embodiment 2, the flange 28 performs the function of the restriction portion.

The retainer 12 has locking portions 63 protruding from the upper portion of the rear surface of each rear abutting portion 44A. As shown in FIG. 10, each locking portion 63 has a rib shape extending in the up-down direction at the center in the left-right direction of the rear surface of the rear abutting portion 44A.

When the retainer 12 is at the actual locking position relative to the housing 11, the rear abutting portions 44A fit into the respective recesses 65 between the abutted portions 37 and the flanges 28, and the locking portions 63 elastically proceed into the respective through-holes 41 and comes into contact with the inner lower surfaces of the through-holes 41. Thus, the locking portion 63 of each rear abutting portion 44A comes into contact with the inner lower surface of the corresponding through-hole 41, thereby restricting the downward displacement of the rear abutting portion 44A in the direction away from the housing 11.

According to Embodiment 2, the retainer 12 is not only held by the front portion 25 of the housing 11 due to the locking effect between the front holders 54 and the front held portions 32 and the locking effect between the holders 34 and the held portions 57, but is also held by the rear portion 26 of the housing 11 due to the locking effect between the locking portions 63 and the flange 28. As a result, the retainer 12 is held in a balanced manner in the front-back direction by the front portion 25 and the rear portion 26 of the housing 11.

### Other Embodiments of the Present Disclosure

The above-described Embodiment 1 disclosed herein is illustrative in all respects and should not be considered restrictive.

In the above-described Embodiment 1, the retainer has a front mask as a front abutting portion. In contrast, according to another embodiment, the retainer may have, as a front butting portion, a dedicated section that comes into contact with the front portion of the housing from the front, rather than the front mask.

In the above-described Embodiment 1, both the rear abutting portions and the abutted portions have dovetail slopes. In contrast, according to another embodiment, only either the other-side abutting portions or the abutted portions may have dovetail slopes. Alternatively, a configuration may be employed in which neither the other-side abutted portions nor the abutted portions have dovetail slopes, and they merely have faces that come into contact with each other along the left-right direction.

In the above-described Embodiment 1, the abutted portions that come into contact with the rear abutting portions are formed on the left and right side surfaces of the rear portion. In contrast, according to another embodiment, the abutted portions that come into contact with the rear abutting portions may alternatively be formed on the inside of the rear portion.

In Embodiment 1, the housing has a polygonal cross section. In contrast, according to another embodiment, the housing may alternatively have a circular cross section. Even in the case where the housing of the present disclosure has a circular cross section, it is sufficient that the attachment hole is open in three directions out of four directions, namely the upward, downward, leftward, and rightward directions of the housing.

### LIST OF REFERENCE NUMERALS

10 Connector
11 Housing
12 Retainer
13 Upper surface
14 Lower surface
15 Left and right side surfaces
16 Front surface
17 Rear surface
18 Cavity
19 Lance
21 Lock arm
22 Side end portion
23 Base end portion
24 Attachment hole
25 Front portion
26 Rear portion
27 Joint portion
28 Flange
29 Eave portion
31 Guide groove
32 Front held portion
33 Step surface
34 Holder
35 Rear step surface
36 Attachment surface
37 Abutted portion
38 Restriction portion
39 Dovetail slop (of abutted portion)
41 Through-hole
42 Retainer body
43 Front mask (front abutting portion)
44, 44A Rear abutting portion
45 Insertion hole
46 Stopping portion
47 Tab insertion hole
48 Jig insertion hole
49 Partition
51 Division wall
52 End surface
53 Guide rib
54 Front holder
55 Side portion
56 Connecting portion
57 Held portion
59 Catching portion
61 Recess
62, 62A Dovetail slope (of rear abutting portion)
63 Locking portion
65 Recess
70 Electric wire
80 Terminal fitting
81 Box portion
90 Mating connector
91 Lock receiver
95 Tab
96 Hood

1. A connector comprising:
a terminal fitting;
a housing accommodating the terminal fitting; and
a retainer attached to the housing and restricting withdrawal of the terminal fitting from the housing,
wherein the housing has:
an attachment hole that is open in three directions out of four directions that are upward, downward, leftward, and rightward directions intersecting with a fitting direction in which the connector is to fit into a mating connector; and
a front portion and a rear portion located forward and rearward, respectively, of the attachment hole with respect to the fitting direction, and
the retainer has:
a retainer body located inside the attachment hole;
a front abutting portion located forward of the retainer body and in contact with the front portion from front; and
rear abutting portions located rearward of the retainer body and in contact with the rear portion from rear,
a pair of the rear abutting portions are formed at ends in a left-right direction of the retainer,
the rear portion has, on left and right side surfaces thereof, abutted portions in contact with the respective rear abutting portions,
the retainer has catching portions each having a hook shape in a side view, the catching portions being formed by the rear abutting portions and a pair of left and right connecting portions extending from respective ends in the left-right direction of the retainer body to the respective rear abutting portions,
a pair of the catching portions are formed, and the two catching portions are spaced apart from each other in the left-right direction, and
the abutted portions each have a protruding shape fitted into respective recesses formed between a rear surface of the retainer body, front surfaces of the rear abutting portions, and the connecting portions.

2. The connector according to claim 1,
wherein front surfaces of the abutted portions are seamlessly continuous with an inner surface of the attachment hole.

3. The connector according to claim 1,
wherein the catching portions each have an L-shape in a side view, and the abutted portions each have a rectangular prism shape.

4. The connector according to claim 3,
wherein the rear portion has restriction portions located rearward of the respective abutted portions, and the rear abutting portions are sandwiched between the respective restriction portions and the respective abutted portions, and
the abutted portions are in contact with the front surfaces of the respective rear abutting portions, and the restriction portions are located in contact with rear surfaces of the rear abutting portions.

5. The connector according to claim 2,
wherein mutually opposing faces of each of the rear abutting portions and a corresponding one of the abutted portions are dovetail slopes in contact with each other in a direction in which the rear abutting portion expands from the abutted portion outward in the left-right direction.

6. The connector according to claim 1,
wherein the front abutting portion is a front mask covering a front surface of the front portion.
